(19) United States
(12) Patent Application Publication
(10) Pub. No.: US 2024/0012609 A1
(43) Pub. Date: Jan. 11, 2024

(54) INFORMATION PROCESSING DEVICE, INFORMATION PROCESSING SYSTEM, AND INFORMATION PROCESSING METHOD

(71) Applicant: Sony Group Corporation, Tokyo (JP)

(72) Inventors: Yuri Kusakabe, Tokyo (JP); Junya Suzuki, Kanagawa (JP); Tsutomu Fuzawa, Tokyo (JP)

(73) Assignee: Sony Group Corporation, Tokyo (JP)

(21) Appl. No.: 18/265,238

(22) PCT Filed: Dec. 1, 2021
(86) PCT No.: PCT/JP2021/044052

§ 371 Date: Jun. 2, 2023

(30) Foreign Application Priority Data
Dec. 10, 2020 (JP) 2020-205395

(51) Int. Cl. G06F 3/16

(52) U.S. Cl. CPC G06F 3/165

(57) ABSTRACT

An information processing device (1) according to the present disclosure includes a storage unit (3), an acquisition unit (41), a calculation unit (42), and a processing unit (43). The storage unit (3) stores position information of a destination and sound information corresponding to the destination. The acquisition unit (41) acquires position information of a user. The calculation unit (42) calculates a distance from the user to the destination on the basis of the position information of the destination and the position information of the user. According to the distance, the processing unit (43) switches a virtual point sound source and a virtual surround sound source and causes the sound information to be output.

### FIELD

The present disclosure relates to an information processing device, an information processing system, and an information processing method.

### BACKGROUND

There is a guidance service system in which, when a user inputs a destination by using a mobile terminal, a route to the destination is divided into a plurality of service ranges and a robot arranged in each of the service ranges provides route guidance to the user by sound (see, for example, Patent Literature 1).

### CITATION LIST

### Patent Literature

Patent Literature 1: JP 2020-32529 A

### SUMMARY

### Technical Problem

However, in the above-described conventional technology, in a case where a user is a visually impaired person, it is not possible to newly discover things present around him/her on a guided route other than the destination.

Thus, the present disclosure proposes an information processing device, an information processing system, and an information processing method with which a visually impaired person can newly discover things present around him/her during moving.

### Solution to Problem

According to the present disclosure, an information processing device is provided. The information processing device includes a storage unit, an acquisition unit, a calculation unit, and a processing unit. The storage unit stores position information of a destination and sound information corresponding to the destination. The acquisition unit acquires position information of a user. The calculation unit calculates a distance from the user to the destination on the basis of the position information of the destination and the position information of the user. According to the distance, the processing unit switches a virtual point sound source and a virtual surround sound source and causes the sound information to be output.

### BRIEF DESCRIPTION OF DRAWINGS

FIG. 1 is a view illustrating an example of an information processing method according to the present disclosure.

FIG. 2 is a view illustrating a configuration example of an information processing system according to the present disclosure.

FIG. 3 is a view illustrating an output example of sound information according to the present disclosure.

FIG. 4 is a view illustrating an example of the sound information according to the present disclosure.

FIG. 5 is a view illustrating a movement example of a user of a case where a plurality of stores is close to each other.

FIG. 6 is a view illustrating how to output the sound information in a case where the plurality of stores is close to each other.

FIG. 7 is a view illustrating how to output the sound information in a case where the plurality of stores is close to each other.

FIG. 8 is a view illustrating how to output the sound information in a case where the plurality of stores is close to each other.

FIG. 9 is a view illustrating how to output the sound information in a case where the plurality of stores is close to each other.

FIG. 10 is a flowchart illustrating an example of processing executed by an information processing device according to the present disclosure.

### DESCRIPTION OF EMBODIMENTS

In the following, embodiments of the present disclosure will be described in detail on the basis of the drawings. Note that in each of the following embodiments, overlapped description is omitted by assignment of the same reference sign to the same parts. Hereinafter, an information processing device, an information processing system, and an information processing method that provide sound information to a visually impaired person will be described as an example. However, a technology according to the present disclosure can also provide the sound information to a healthy person.

[1. Problem]

In general, when a visually impaired person goes out, content to be consumed is determined in advance, and an approaching method with respect thereto is carefully examined in advance. For example, the visually impaired person asks a store clerk of a target store or a companion about a position of a desired product, and ask for guidance. Thus, it is almost impossible for the visually impaired person to experience a chance encounter on site.

In addition, a store does not emit a sound including detailed information to be a decisive factor of determination, and it is difficult for the visually impaired person to make determination by relying only on sound. However, when the information is read as text by a device of the store, it takes time and effort for the visually impaired person to interpret the language, and it becomes difficult for him/her to ignore the information that he/she is not interested in.

Thus, the present disclosure proposes an information processing device, an information processing system, and an information processing method with which a visually impaired person can newly discover things present around him/her during moving.

[2. Example of an Information Processing Method]

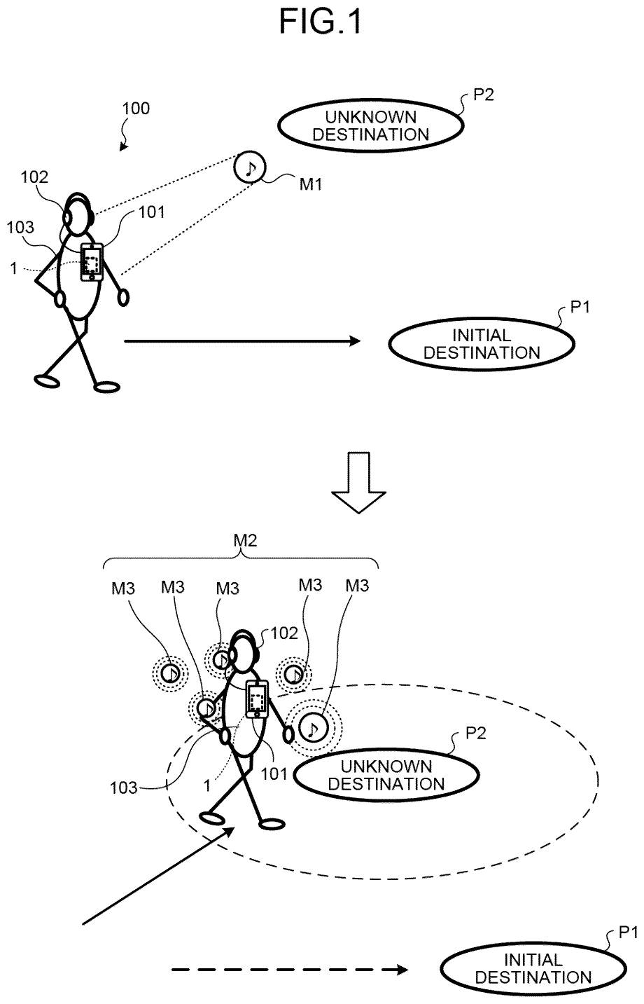

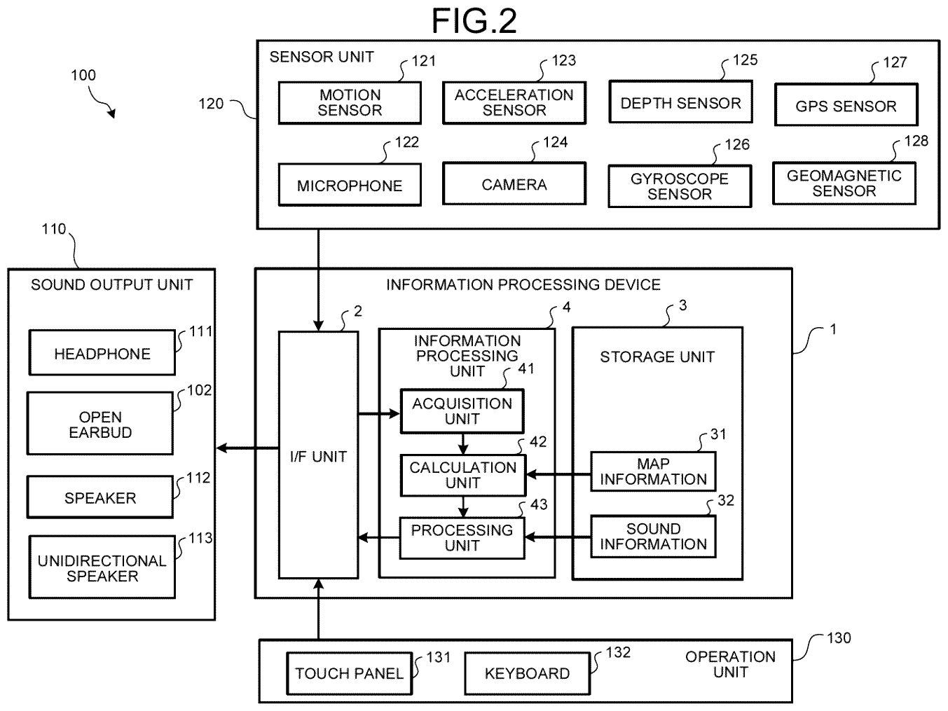

FIG. 1 is a view illustrating an example of an information processing method according to the present disclosure. As illustrated in FIG. 1, an information processing system 100 according to the present disclosure includes a terminal device 101 including an information processing device 1, and open earbuds 102 connected to the terminal device 101. A configuration example of the information processing device 1 according to the present disclosure will be described later with reference to FIG. 2.

The terminal device 101 is, for example, a smartphone carried by a user 103. The open earbuds 102 are earbuds of a type that does not block ear holes. Note that the information processing system 100 may include a speaker, headphones, or the like instead of the open earbuds 102.

Here, as an example, a case where the information processing device 1 causes the open earbuds 102 to output sound information and provides the sound information to the user 103 while the user 103 who is a visually impaired person is moving to an initial destination P1 will be described. In addition, here, it is assumed that a destination P2 unknown to the user 103 is present in the vicinity of the initial destination P1.

The information processing device 1 stores position information of a plurality of destinations and pieces of sound information respectively corresponding to the destinations. Furthermore, the information processing device has a function of acquiring position information of the user 103 from various sensors included in the terminal device 101.

As illustrated in an upper view of FIG. 1, the user 103 may go to the initial destination P1 depending on a route checked in advance, a braille block, or the like. In such a case, the information processing device 1 acquires the position information of the user 103 and position information of the unknown destination P2 present in the vicinity of the user 103. Then, the information processing device 1 calculates a distance from the user 103 to the unknown destination P2 on the basis of the position information of the unknown destination P2 and the position information of the user 103.

Subsequently, the information processing device 1 suggests a direction and a position of the unknown destination P2 to the user 103 by causing a virtual point sound source M1 to output sound information corresponding to the unknown destination P2.

By using a head related transfer function (HRTF), the information processing device 1 arranges one virtual point sound source in a virtual sound field space by the open earbuds 102, and suggests the direction and the position of the unknown destination P2 to the user 103. As a result, the information processing system 100 can notify the user 103 of the presence of the unknown destination P2 present around the user 103.

As illustrated in a lower view of FIG. 1, when the user 103 pays attention to the unknown destination P2 and approaches the unknown destination P2, the information processing device 1 causes a virtual surround sound source M2 (such as 5.1 ch, 7.1 ch, or the like) to output sound information associated with the unknown destination P2.

The information processing device 1 configures the virtual surround sound source M2 by simultaneously arranging a plurality of virtual point sound sources M3 at positions surrounding the user 103 in the virtual sound field space by using the head related transfer function. The information processing device 1 uses all audio reproduction methods including spatial audio technology such as Virtualizer for arrangement of the virtual surround sound source M2. As described above, the information processing device 1 switches the virtual point sound source M1 and the virtual surround sound source M2 according to the distance from the user 103 to the unknown destination P2, and causes the sound information to be output.

In such a manner, when the user 103 approaches the unknown destination P2, the information processing device 1 makes the user 103 hear the sound information corresponding to the unknown destination P2 with realistic sound. As a result, the information processing device 1 can cause the user 103 who is moving to discover that there is a new thing around him/her.

[3. Configuration of an Information Processing System]

FIG. 2 is a view illustrating a configuration example of an information processing system according to the present disclosure. As illustrated in FIG. 2, the information processing system 100 includes the information processing device 1 and a sound output unit 110. The information processing device 1 is connected to the sound output unit 110 in a wired or wireless manner, and outputs sound information to the sound output unit 110. The information processing device 1 is also connected to a sensor unit 120 and an operation unit 130.

The sound output unit 110 includes at least one of headphones 111, open earbuds 102, a speaker 112, or a unidirectional speaker 113. The sound output unit 110 is preferably the open earbuds 102 that does not block ambient sound in a case of causing the user 103 who is moving to hear the sound information.

The sensor unit 120 includes a motion sensor 121, a microphone 122, an acceleration sensor 123, a camera 124, a depth sensor 125, a gyroscope sensor 126, a global positioning system (GPS) 127, and a geomagnetic sensor 128 mounted on the terminal device 101.

In a place where a GPS satellite can be captured, the sensor unit 120 measures the position of the user 103 by the GPS sensor 127 and outputs the position information to the information processing device 1. For example, in a place where the GPS satellite cannot be captured, such as the interior or a basement, the sensor unit 120 uses a sensor other than the GPS sensor 127, measures the position of the user 103 by a pedestrian dead-reckoning (PDR) technology, and outputs the position information to the information processing device 1.

The operation unit 130 includes a touch panel 131 mounted on the terminal device 101. The operation unit 130 may be a keyboard 132 connected to the terminal device 101. The operation unit 130 receives, for example, an input operation of various settings by the user 103, and outputs a signal to the information processing device 1 according to the input operation.

The information processing device 1 includes an I/F unit 2, a storage unit 3, and an information processing unit 4. The I/F unit 2 is a communication interface that transmits and receives various kinds of information between the information processing device 1 and the sound output unit 110, the sensor unit 120, and the operation unit 130.

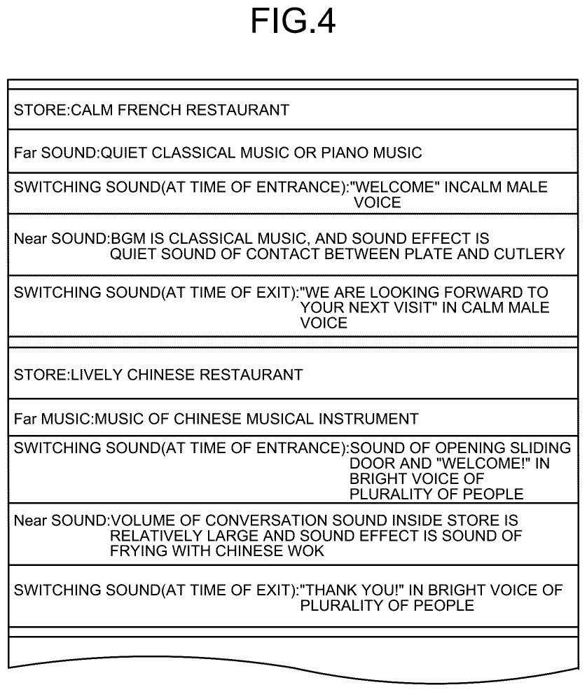

The storage unit 3 is, for example, an information storage device such as data flash, and stores map information 31 and sound information 32. The map information 31 is information of a map including position information of a plurality of destinations. The sound information 32 is information of sound corresponding to each of the destinations. An example of the sound information 32 will be described later with reference to FIG. 4.

The information processing unit 4 includes a microcomputer including a central processing unit (CPU), a read only memory (ROM), a random access memory (RAM), and the like, and various circuits. The information processing unit 4 includes an acquisition unit 41, a calculation unit 42, and a processing unit 43 that function when the CPU executes a program stored in the ROM by using the RAM as a work area.

Note that a part or all of the acquisition unit 41, the calculation unit 42, and the processing unit 43 included in the information processing unit 4 may include hardware such as an application specific integrated circuit (ASIC) or a field programmable gate array (FPGA).

The acquisition unit 41, the calculation unit 42, and the processing unit 43 included in the information processing unit 4 implement or execute an action of information processing described in the following. Note that an internal configuration of the information processing unit 4 is not limited to the configuration illustrated in FIG. 2, and may be another configuration as long as being a configuration of performing information processing described later.

The acquisition unit 41 acquires the position information of the user 103 from the sensor unit 120 via the I/F unit 2 and outputs the position information to the calculation unit 42. The calculation unit 42 calculates the distance from the user 103 to the destination on the basis of the position information of the destination, the position information being included in the map information 31, and the position information of the user 103, the position information being input from the acquisition unit 41, and outputs the distance to the processing unit 43.

The processing unit 43 outputs the sound information 32, on which the processing of switching the virtual point sound source M1 and the virtual surround sound source M2 is performed according to the distance input from the calculation unit 42, to the sound output unit 110 via the I/F unit 2 and causes the sound output unit 110 to output the sound.

The processing unit 43 causes the virtual point sound source M1 to output the sound information 32 in a situation in which the distance input from the calculation unit 42 exceeds a threshold (such as 1 m), and causes the virtual surround sound source M2 to output the sound information 32 when the distance input from the calculation unit 42 is equal to or shorter than the threshold.

At this time, in the situation in which the distance input from the calculation unit 42 exceeds the threshold, the processing unit 43 arranges one virtual point sound source in a direction in which the destination is present, and causes the sound information 32 suggesting the presence of the destination to be output.

Then, when the distance input from the calculation unit 42 becomes the threshold, the processing unit 43 arranges the plurality of virtual point sound sources M3 around the user 103 and causes the sound information 32 associated with an atmosphere of the destination to be output. In a case of switching the virtual point sound source M1 and the virtual surround sound source, the processing unit 43 causes an output of a switching sound indicating the switching.

[4. Output Example of Sound Information]

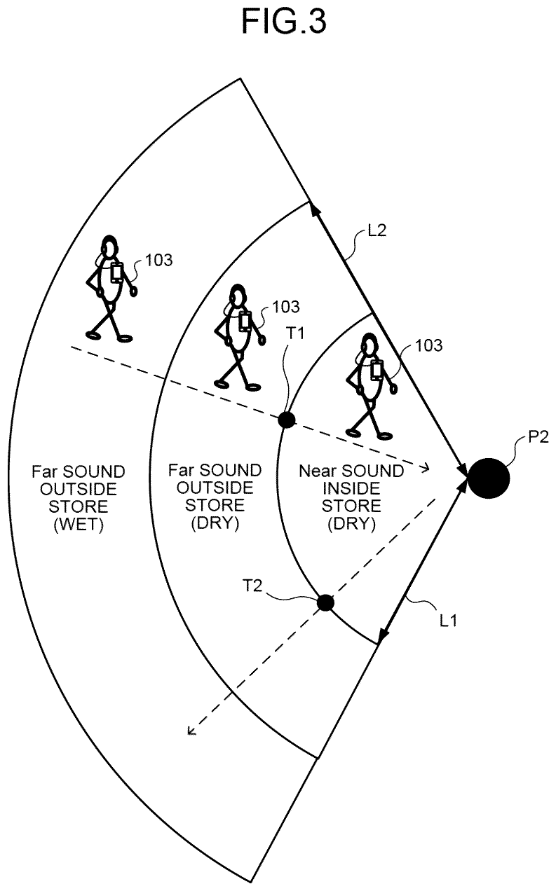

FIG. 3 is a view illustrating an output example of sound information according to the present disclosure. A case where the unknown destination P2 is a store will be described in the following. Thus, hereinafter, the unknown destination P2 may be referred to as a store P2.

As illustrated in FIG. 3, in a case where a distance from the store P2 to the user 103 exceeds a threshold L1, the information processing device 1 causes the virtual point sound source M1 to output a Far sound that is the sound information 32 for the outside of the store. At this time, when the distance from the store P2 to the user 103 is equal to or longer than a predetermined distance L2, the processing unit 43 causes an output of a Far sound (wet) that is the sound information 32 acquired by processing the sound. For example, the processing unit 43 generates the Far sound (wet) with a sound spread by applying an effect such as reverb to the sound information 32.

Furthermore, in a case where the distance from the store P2 to the user 103 exceeds the threshold L1, when the distance from the store P2 to the user 103 is shorter than the predetermined distance L2, the processing unit 43 causes an output of a Far sound (dry) that is the sound information 32 acquired without processing of the sound. The Far sound (dry) gives a sharper impression to a listener than the Far sound (wet).

Furthermore, when the distance from the store P2 to the user 103 becomes equal to or shorter than the threshold L1, the information processing device 1 causes the virtual surround sound source M2 to output a Near sound (dry) that is the sound information 32 for the inside of the store. The processing unit 43 causes the switching sound to be output at timing T1 at which the sound information 32 to be output is switched from the Far sound to the Near sound. Furthermore, the processing unit 43 causes the switching sound to be output also at timing T2 at which the sound information 32 to be output is switched from the Near sound to the Far sound. [5. Example of sound information]

FIG. 4 is a view illustrating an example of sound information according to the present disclosure. As illustrated in FIG. 4, for example, in a case where the destination store is a “calm French restaurant”, the information processing device 1 causes “quiet classical music or piano music” to be output as the Far sound. The information processing device 1 outputs a sound “Welcome” in a calm male voice as the switching sound at the time of an entrance to the store.

As the Near sound, the information processing device 1 causes “classical music” to be output as BGM and “quiet sound of a contact between a plate and cutlery” to be output as a sound effect. The information processing device 1 causes a sound “We are looking forward to your next visit” to be output in the calm male voice as the switching sound at the time of an exit from the store.

Furthermore, in a case where the destination store is a “lively Chinese restaurant”, the information processing device 1 causes “music of a Chinese musical instrument” to be output as the Far sound. The information processing device 1 causes sounds such as a “sound of opening a sliding door” and “Welcome!” in bright voices of a plurality of people to be output as switching sounds at the time of an entrance to the store.

As the Near sound, the information processing device 1 causes a conversation sound in the store to be output in relatively large volume and a “sound of frying with a Chinese wok” to be output as the sound effect. The information processing device 1 causes a sound “Thank you!” to be output in the bright voices of the plurality of people as the switching sound at the time of an exit from the store.

As described above, the information processing device 1 suggests the presence of the store to the user 103 by the Far sound having a small amount of information, and causes the user 103 to specifically associate the atmosphere of the store by the Near sound having a large amount of information.

For example, the information processing device 1 causes the BGM or a sound logo, which reminds the user of the store, to be reproduced up to one meter from a front of a door of the store. As the user 103 approaches the store, volume of the BGM is changed to be larger and clearer.

When the distance to the store reaches one meter, the information processing device 1 causes the virtual surround sound source to reproduce a sound reminding the atmosphere inside the store together with a voice of “Welcome!”. When the store is the Chinese restaurant, the information processing device 1 causes a sound of splashing oil, a sound of hitting a Chinese wok, a voice of a bright and lively store clerk, rattles of customers, and the like to be reproduced. Information inside the store may be read as text.

As described above, according to the information processing system 100 according to the present disclosure, the user 103 can notice presence of a new object or thing around him/her which object or thing is overlooked until then, and can acquire information related to the object or thing in a broad overview.

[6. How to Output Sound Information in a Case where a Plurality of Stores is Close to Each Other]

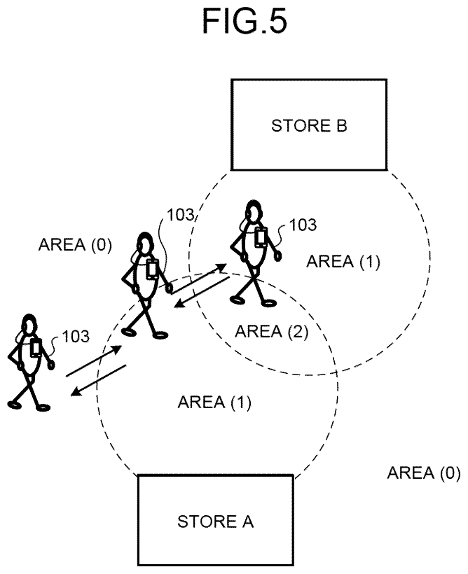

Although a case where the user 103 approaches the one unknown destination P2 has been described in the above, there is a case where the user 103 approaches a plurality of close unknown destinations. FIG. 5 is a view illustrating a movement example of a user in a case where a plurality of stores is close to each other. Hereinafter, a case where two stores that are a store A and a store B that can be a destination of the user 103 are opened in the vicinity in a manner of facing each other will be described.

For example, as illustrated in FIG. 5, there is a case where two stores that are the store A and the store B that can be the destination of the user 103 are opened in the vicinity in a manner of facing each other. An area indicated by a dashed circle partially overlapping with the store A is an area in which a Near sound related to the store A is output. An area indicated by a dashed circle partially overlapping with the store B is an area in which a Near sound related to the store B is output.

In this case, the user 103 may go back and forth between an area in which the Near sound of none of the stores A and B is output and an area in which the Near sound of the store A is output. In this case, the information processing device 1 causes the sound information 32 to be output by processing similar to that of when the user 103 approaches the one unknown destination P2 (see FIG. 3).

Furthermore, for example, the user 103 may move between an area in which the Near sound of the store A is output and an area in which the Near sound of the store B is output overlaps with each other, and an area in which the Near sound of the store A is output.

At this time, when the information processing device 1 causes the user 103 located in the area, in which the area where the Near sound of the store A is output and the area where the Near sound of the store B is output overlap with each other, to simultaneously hear the Near sounds having a large information amount of the two stores A and B, the user 103 is confused. Thus, in a case where a plurality of stores is close to each other, the information processing device 1 performs processing different from that of a case where the user 103 approaches the one unknown destination P2.

Hereinafter, an area in which the Near sound of none of the stores A and B is output is referred to as an area (0). In the area in which the Near sound of the store A is output and the area in which the Near sound of the store B is output, an area in which the two areas do not overlap with each other is referred to as an area (1). In the area in which the Near sound of the store A is output and the area in which the Near sound of the store B is output, an area in which the two areas overlap with each other is referred to as an area (2).

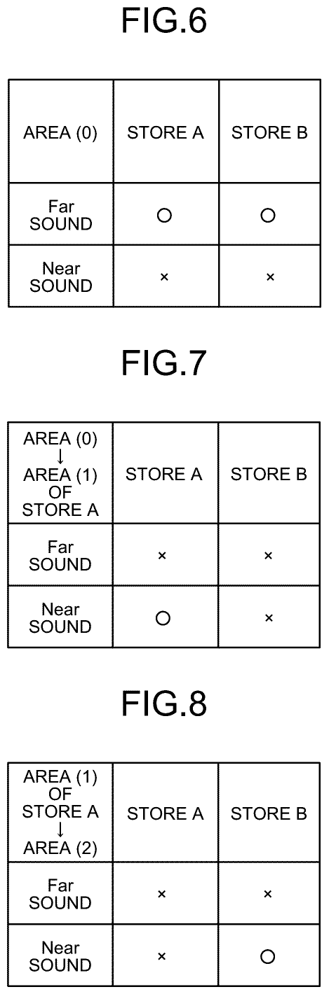

FIG. 6 to FIG. 9 are views illustrating how to output sound information in a case where a plurality of stores is close to each other. “0” illustrated in FIG. 6 to FIG. 9 indicates that “there is a sound output”, and “x” indicates that “there is no sound output”. In a case of outputting the Far sound, the information processing device 1 causes the virtual point sound source M1 to output the sound. In a case of outputting the Near sound, the information processing device 1 causes the virtual surround sound source M2 to output the sound.

As illustrated in FIG. 6, in a case where the user 103 is in the area (0), the information processing device 1 causes the Far sound of the store A and the Far of the store B to be output. At this time, the information processing device 1 does not cause the Near sound of the store A and the Near sound of the store B to be output.

Then, as illustrated in FIG. 7, when the user 103 enters the area (1) of the store A from the area (0), the information processing device 1 stops the output of the Far sound of the store A and the Far sound of the store B. Then, the information processing device 1 outputs the Near sound of the store A. At this time, the information processing device 1 does not cause the Near sound of the store B to be output.

Then, as illustrated in FIG. 8, when the user 103 enters the area (2) from the area (1) of the store A, the information processing device 1 stops the output of the Near sound of the store A and causes the Near sound of the store B to be output.

Although not illustrated here, there is a case where the user 103 enters an area (0) of the store B from the area (0). In this case, when the user 103 enters the area (1) of the store B from the area (0), the information processing device 1 stops the output of the Far sound of the store A and the Far sound of the store B. Then, the information processing device 1 causes the Near sound of the store B to be output. At this time, the information processing device 1 does not cause the Near sound of the store A to be output.

Then, when the user 103 enters the area (2) from the area (1) of the store B, the information processing device 1 the information processing device 1 stops the output of the Near sound of the store B and causes the Near sound of the store A to be output.

As described above, in a case where there is a plurality of destinations distances to which from the user 103 are equal to or shorter than a threshold L1, the processing unit 43 of the information processing device 1 causes the virtual surround sound source M2 to output the sound information 32 corresponding to a destination a distance to which becomes equal to or shorter than the threshold L at the latest timing, and stops the output of the sound information 32 corresponding to the other destination.

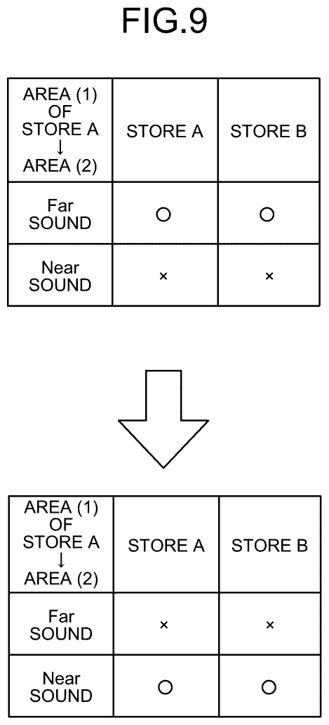

Furthermore, in a case where the user 103 enters the area (2) from the area (1) of the store A, the information processing device 1 can also cause the sound information 32 to be output in the following manner. For example, as illustrated in an upper view of FIG. 9, when the user 103 enters the area (2) from the area (1) of the store A, the information processing device 1 causes the Far sound of the store A and the Far sound of the store B to be output temporarily.

At this time, the information processing device 1 does not cause the Near sound of the store A and the Near sound of the store B to be output. Then, as illustrated in a lower view of FIG. 9, the information processing device 1 gradually performs switching from the Far sound of the store A and the Far sound of the store B to the Near sound of the store A and the Near sound of the store B, and causes the sounds to be output. As a result, in a case where the user 103 enters the area (2), the information processing device 1 can suppress that the Near sound of the store A and the Near sound of the store B are suddenly and simultaneously output and the user 103 is confused.

As described above, in a case where there is the plurality of destinations the distances to which from the user 103 are equal to or shorter than the threshold L, the information processing device 1 can cause the virtual point sound source to output pieces of the sound information 32 respectively corresponding to all the destinations the distances to which are equal to or shorter than the threshold L, and then can gradually switch the virtual point sound source to the virtual surround sound source and cause the sound information 32 to be output.

[7. Processing Executed by an Information Processing Device]

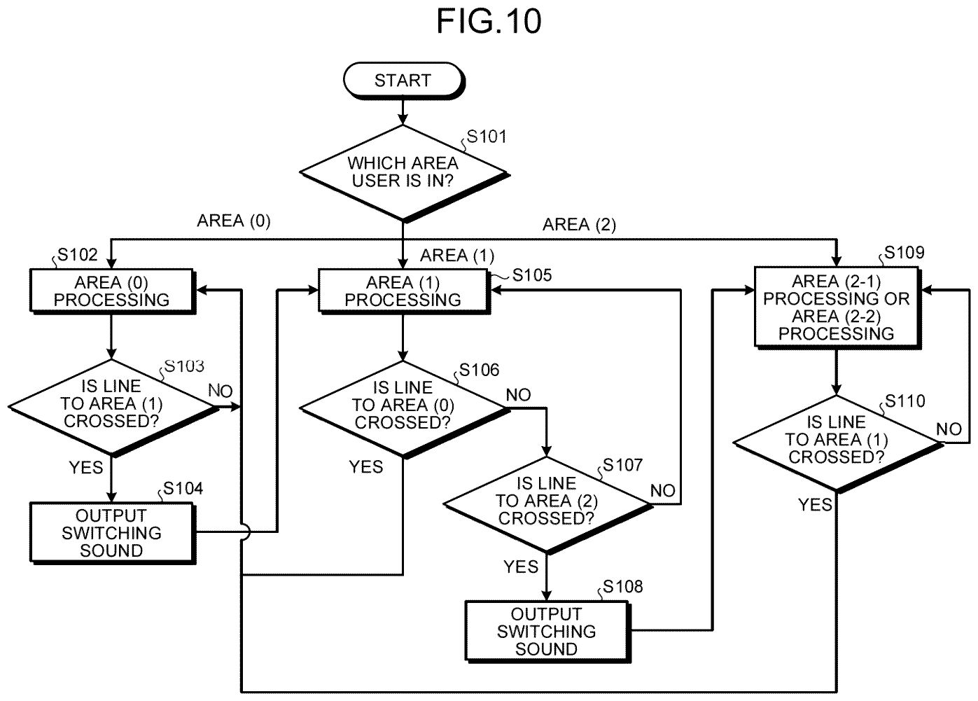

FIG. 10 is a flowchart illustrating an example of processing executed by an information processing device according to the present disclosure. As illustrated in FIG. 10, the information processing device 1 first determines an area in which the user 103 is located (Step S101). In a case of determining that the area in which the user 103 is located is the area (0) (Step S101, area (0)), the information processing device 1 performs area (0) processing (Step S102). The area (0) processing is processing according to FIG. 6.

Subsequently, the information processing device 1 determines whether the user 103 crosses a line to the area (1) (Step S103). Then, in a case of determining that the line to the area (1) is not crossed (Step S103, No), the information processing device 1 transitions the processing to Step S102. Furthermore, in a case of determining that the line to the area (1) is crossed (Step S103, Yes), the information processing device 1 causes the switching sound to be output (Step S104) and transitions the processing to Step S105.

Furthermore, in a case of determining that the area in which the user 103 is located is the area (1) (Step S101, area (1)), the information processing device 1 performs area (1) processing. The area (1) processing is, for example, processing according to FIG. 7. Note that in the area (1) processing, in a case where the user 103 enters the area (1) of the store B, the Near sound of the store A in FIG. 7 becomes “x”, and the Near sound of the store B becomes “o”.

Subsequently, the information processing device 1 determines whether the user 103 crosses a line to the area (0) (Step S106). Then, in a case of determining that the line to the area (0) is crossed (Step S106, Yes), the information processing device 1 transitions the processing to Step S102.

Furthermore, in a case of determining that the line to the area (0) is not crossed (Step S106, No), the information processing device 1 determines whether the user 103 crosses a line to the area (2) (Step S107). Then, in a case of determining that the line to the area (2) is not crossed (Step S107, No), the information processing device 1 transitions the processing to Step S105. In a case of determining that the line to the area (2) is crossed (Step S107, Yes), the information processing device 1 causes the switching sound to be output (Step S108) and transitions the processing to Step S109.

In a case of determining that the area in which the user 103 is located is the area (2) (Step S101, area (2)), the information processing device 1 performs area (2-1) processing or area (2-2) processing (Step S109). The area (2-1) processing is, for example, processing according to FIG. 8. Note that in the area (2-1) processing, in a case where the user 103 enters the area (2) from the area (1) of the store B, the Near sound of the store A in FIG. 8 becomes “o”, and the Near sound of the store B becomes “x”. The area (2-2) processing is, for example, processing according to FIG. 9.

Subsequently, the information processing device 1 determines whether the user 103 crosses the line to the area (1) (Step S110). Then, in a case of determining that the line to the area (1) is crossed (Step S110, Yes), the information processing device 1 transitions the processing to Step S102.

Furthermore, in a case of determining that the line to the area (1) is not crossed (Step S110, No), the information processing device 1 transitions the processing to Step S109. The information processing device 1 continues the processing of Step S101 to S110 until an operation of stopping the service of providing the sound information 32 is performed by the user 103 with the operation unit 130.

Note that although the processing of a case where there are two close stores is illustrated as an example in FIG. 10, the information processing device 1 can deal with a case where there are three or more close stores by adding the determination processing.

Although a case where the user 103 is a visually impaired person has been described in the above, the information processing system 100 according to the present disclosure can provide peripheral information to not only the visually impaired person but also a healthy person whose vision is deprived by a smartphone by hearing without difficulty.

Furthermore, by registration of information of likes/tastes of the user and an event in which the user is interested into a service in advance in the information processing device 1, in a case of looking for a new object or thing, it is possible to reduce time of operating a smartphone at a place outside a house, and it is expected that communication with face-to-face conversation is recovered and promoted.

[8. Effect]

The information processing device 1 includes the storage unit 3, the acquisition unit 41, the calculation unit 42, and the processing unit 43. The storage unit 3 stores position information of a destination and sound information 32 corresponding to the destination. The acquisition unit 41 acquires position information of the user 103. The calculation unit 42 calculates a distance from the user 103 to the destination on the basis of the position information of the destination and the position information of the user 103. According to the distance, the processing unit 43 switches the virtual point sound source M1 and the virtual surround sound source M2 and causes the sound information 32 to be output. As a result, the information processing device 1 can cause the user 103 who is moving to discover that there is a new thing around him/her.

The processing unit 43 causes the virtual point sound source M1 to output the sound information 32 in a situation in which the distance exceeds the threshold L1, and causes the virtual surround sound source M2 to output the sound information 32 when the distance becomes equal to or shorter than the threshold L1. As a result, in a case where the user 103 approaches the destination, the information processing device 1 can cause the user 103 to discover that there is a new thing around him/her by realistic sound information.

The processing unit 43 arranges the one virtual point sound source M1 in a direction in which the destination is present and causes the sound information 32 suggesting the presence of the destination to be output in a situation in which the distance exceeds the threshold L1, and arranges the plurality of virtual point sound sources around the user 103 and causes the sound information 32 associated with the atmosphere of the destination to be output when the distance becomes equal to or shorter than the threshold L1. As a result, an information processing device 11 can cause the user 103 to discover more information related to the destination when the distance becomes equal to or longer than the threshold L1.

In a case where there is a plurality of destinations distances to which are equal to or shorter than the threshold L1, the processing unit 43 causes the virtual surround sound source M2 to output the sound information 32 corresponding to the destination a distance to which becomes equal to or shorter than the threshold L1 at the latest timing, and stops the output of the sound information 32 corresponding to other destination. As a result, the information processing device 1 can preferentially provide the user 103 with the sound information 32 related to the latest destination found by the user 103.

In a case where there is a plurality of destinations distances to which are equal to or shorter than the threshold L1, the processing unit 43 causes the virtual point sound source M1 to output pieces of the sound information 32 respectively corresponding to all the destinations the distances to which are equal to or shorter than the threshold L1, and then gradually performs switching from the virtual point sound source M1 to the virtual surround sound source M2 and causes the sound information 32 to be output. As a result, the information processing device 1 can suppress that the pieces of sound information 32 respectively related to the plurality of destinations are suddenly and simultaneously output by the virtual surround sound source M2 and the user 103 is confused.

In a case where the distance exceeds the threshold L1, the processing unit 43 outputs the sound information 32 acquired by processing of the sound when the distance is equal to or longer than the predetermined distance L2, and outputs the sound information 32 acquired without the processing of the sound when the distance is shorter than the predetermined distance L2. As a result, the information processing device 11 can cause the user 103 to grasp the distance from the user 103 to the destination depending on whether the sound is processed in the sound information 32.

In a case of switching the virtual point sound source M1 and the virtual surround sound source M2, the processing unit 43 outputs a switching sound indicating the switching. As a result, the information processing device 1 can cause the user 103 to recognize that the user arrives at the destination or becomes close to the destination.

The processing unit 43 causes the open earbuds 102 to output the sound information 32. As a result, the information processing device 1 can make the user 103 who is moving hear the sound information 32 safely without blocking ambient sound.

The information processing system includes the information processing device 1 and the open earbuds 102. The information processing device 1 includes the storage unit 3, the acquisition unit 41, the calculation unit 42, and the processing unit 43. The storage unit 3 stores position information of a destination and sound information 32 corresponding to the destination. The acquisition unit 41 acquires position information of the user 103. The calculation unit 42 calculates a distance from the user 103 to the destination on the basis of the position information of the destination and the position information of the user 103. According to the distance, the processing unit 43 switches the virtual point sound source M1 and the virtual surround sound source M2 and causes the sound information 32 to be output. As a result, the information processing system can cause the user 103 who is moving to discover that there is a new thing around him/her.

An information processing method includes: storing position information of a destination and sound information 32 corresponding to the destination; acquiring position information of the user 103; calculating a distance from the user 103 to the destination on the basis of the position information of the destination and the position information of the user 103; and switching the virtual point sound source M1 and the virtual surround sound source M2 and causing an output of the sound information 32 according to the distance, the storing, acquiring, calculating, and switching and causing the output being performed by a processor. As a result, the information processing method can cause the user 103 who is moving to discover that there is a new thing around him/her.

Note that the effects described in the present description are merely examples and are not limitations, and there may be another effect.

Note that the present technology can also have the following configurations.
(1)

An information processing device including:
a storage unit that stores position information of a destination and sound information corresponding to the destination;
an acquisition unit that acquires position information of a user;
a calculation unit that calculates a distance from the user to the destination on a basis of the position information of the destination and the position information of the user; and a processing unit that performs switching between a virtual point sound source and a virtual surround sound source and causes the sound information to be output according to the distance.
(2)

The information processing device according to (1), wherein
the processing unit
causes the virtual point sound source to output the sound information in a situation in which the distance exceeds a threshold, and causes the virtual surround sound source to output the sound information when the distance becomes equal to or shorter than the threshold.
(3)

The information processing device according to (2), wherein
the processing unit
arranges the one virtual point sound source in a direction, in which the destination is present, and causes the sound information suggesting the presence of the destination to be output in a situation in which the distance exceeds the threshold, and arranges a plurality of the virtual point sound sources around the user and causes the sound information associated with an atmosphere of the destination to be output when the distance becomes equal to or shorter than the threshold.
(4)

The information processing device according to (2) or (3), wherein
the processing unit
causes, in a case where there is a plurality of the destinations the distances to which are equal to or shorter than the threshold, the virtual surround sound source to output the sound information corresponding to the destination the distance to which becomes equal to or shorter than the threshold at latest timing, and stops the output of the sound information corresponding to the other destination.
(5)

The information processing device according to any one of (2) to (4), wherein
the processing unit
causes, in a case where there is a plurality of the destinations the distances to which are equal to or shorter than the threshold, the virtual point sound source to output pieces of the sound information respectively corresponding to all the destinations the distances to which are equal to or shorter than the threshold, and then gradually switches the virtual point sound source to the virtual surround sound source and causes the sound information to be output.
(6)

The information processing device according to any one of (2) to (5), wherein the processing unit causes the sound information acquired by processing of sound to be output when the distance is equal to or longer than a predetermined distance, and causes the sound information acquired without the processing of the sound to be output when the distance is shorter than the predetermined distance in a case where the distance exceeds the threshold.
(7)

The information processing device according to any one of (1) to (6), wherein the processing unit causes, in a case of switching the virtual point sound source and the virtual surround sound source, a switching sound indicating the switching to be output.
(8)

8. The information processing device according to any one of (1) to (7), wherein
the processing unit
causes open earbuds to output the sound information.
(9)

An information processing system including:
an information processing device including
a storage unit that stores position information of a destination and sound information corresponding to the destination,
an acquisition unit that acquires position information of a user,
a calculation unit that calculates a distance from the user to the destination on a basis of the position information of the destination and the position information of the user, and
a processing unit that performs switching between a virtual point sound source and a virtual surround sound source and causes the sound information to be output according to the distance calculated by the calculation unit; and open earbuds that output the sound information.
(10)

An information processing method including:
storing position information of a destination and sound information corresponding to the destination;
acquiring position information of a user;
calculating a distance from the user to the destination on a basis of the position information of the destination and the position information of the user; and
switching a virtual point sound source and a virtual surround sound source and causing an output of the sound information according to the distance,
the storing, acquiring, calculating, and switching and causing the output being performed by a processor.

### REFERENCE SIGNS LIST

100 INFORMATION PROCESSING SYSTEM
101 TERMINAL DEVICE
102 OPEN EARBUDS
103 USER
1 INFORMATION PROCESSING DEVICE
2 I/F UNIT
3 STORAGE UNIT
31 MAP INFORMATION
32 SOUND INFORMATION
4 INFORMATION PROCESSING UNIT
41 ACQUISITION UNIT
42 CALCULATION UNIT
43 PROCESSING UNIT
110 SOUND OUTPUT UNIT
120 SENSOR UNIT
130 OPERATION UNIT
M1 VIRTUAL POINT SOUND SOURCE
M2 VIRTUAL SURROUND SOUND SOURCE

1. An information processing device comprising:
a storage unit that stores position information of a destination and sound information corresponding to the destination;
an acquisition unit that acquires position information of a user;
a calculation unit that calculates a distance from the user to the destination on a basis of the position information of the destination and the position information of the user; and
a processing unit that performs switching between a virtual point sound source and a virtual surround sound source and causes the sound information to be output according to the distance.

2. The information processing device according to claim 1, wherein
the processing unit
causes the virtual point sound source to output the sound information in a situation in which the distance exceeds a threshold, and causes the virtual surround sound source to output the sound information when the distance becomes equal to or shorter than the threshold.

3. The information processing device according to claim 2, wherein
the processing unit
arranges the one virtual point sound source in a direction, in which the destination is present, and causes the sound information suggesting the presence of the destination to be output in a situation in which the distance exceeds the threshold, and arranges a plurality of the virtual point sound sources around the user and causes the sound information associated with an atmosphere of the destination to be output when the distance becomes equal to or shorter than the threshold.

4. The information processing device according to claim 2, wherein
the processing unit
causes, in a case where there is a plurality of the destinations the distances to which are equal to or shorter than the threshold, the virtual surround sound source to output the sound information corresponding to the destination the distance to which becomes equal to or shorter than the threshold at latest timing, and stops the output of the sound information corresponding to the other destination.

5. The information processing device according to claim 2, wherein
the processing unit
causes, in a case where there is a plurality of the destinations the distances to which are equal to or shorter than the threshold, the virtual point sound source to output pieces of the sound information respectively corresponding to all the destinations the distances to which are equal to or shorter than the threshold, and then gradually switches the virtual point sound source to the virtual surround sound source and causes the sound information to be output.

6. The information processing device according to claim 2, wherein
the processing unit
causes the sound information acquired by processing of sound to be output when the distance is equal to or longer than a predetermined distance, and causes the sound information acquired without the processing of the sound to be output when the distance is shorter than the predetermined distance in a case where the distance exceeds the threshold.

7. The information processing device according to claim 1, wherein
the processing unit
causes, in a case of switching the virtual point sound source and the virtual surround sound source, a switching sound indicating the switching to be output.

8. The information processing device according to claim 1, wherein
the processing unit
causes open earbuds to output the sound information.

9. An information processing system comprising:
an information processing device including
a storage unit that stores position information of a destination and sound information corresponding to the destination,
an acquisition unit that acquires position information of a user,
a calculation unit that calculates a distance from the user to the destination on a basis of the position information of the destination and the position information of the user, and
a processing unit that performs switching between a virtual point sound source and a virtual surround sound source and causes the sound information to be output according to the distance calculated by the calculation unit; and
open earbuds that output the sound information.

10. An information processing method comprising:
storing position information of a destination and sound information corresponding to the destination;
acquiring position information of a user;
calculating a distance from the user to the destination on a basis of the position information of the destination and the position information of the user; and
switching a virtual point sound source and a virtual surround sound source and causing an output of the sound information according to the distance,
the storing, acquiring, calculating, and switching and causing the output being performed by a processor.
